(19) United States
(12) Patent Application Publication
(10) Pub. No.: US 2004/0203627 A1
(43) Pub. Date: Oct. 14, 2004

(54) Wireless communications device that records voice messages

(76) Inventor: Robert Courtney Loomis, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/347,065

(22) Filed: Jan. 17, 2003

(51) Int. Cl. H04M 11/10

(52) U.S. Cl. 455/413; 455/412.1

(57) ABSTRACT

A method of indicating that a voice message to be transmitted by transmitting device is to be recorded by a receiving device includes receiving a selection that causes the transmitting device to enter a voice-messaging mode. The method also includes receiving a voice message from a user and generating a nonaudible signal that indicates to the receiving device that the voice message is to be recorded by the receiving device.

### BACKGROUND OF THE INVENTION

In a Family Radio Service communications system, a collection of users selects one of several communications channels to communicate with other users within the collection. Typically, the users within the collection agree on a communications channel that is not currently in use by other collections of users. This allows the users within the collection to communicate with each other using Family Radio Service communications devices with little or no interference from other users communicating by way of similar devices. Family Radio Service devices provide point-to-point communications between users dispersed over short distances, such as within two miles of each other.

In a Family Radio Service communications system, a user within the collection can use a call signal to contact the other users of the collection. When a receiving device receives a call signal, the device emits an audible signal that notifies the user of the receiving device that a user within the collection is calling. The user receiving the call can then initiate communications with the calling user and with others within the collection as desired.

However, when the receiving device receives a call signal, the user may not be in a position to immediately respond to the received call signal. For example, the receiving communications device may at a location where a high-level of ambient noise prevents the user from hearing the audible signal. In this event, the user initiating the call may be required to transmit the call signal multiple times over a considerable period of time before being able to convey a voice message to the receiving user.

### BRIEF DESCRIPTION OF THE DRAWINGS

FIG. 1 is a block diagram of a wireless transmitting device that accords with an embodiment of the invention;

FIG. 2 is a block diagram of a wireless receiving device that accords with an embodiment of the invention;

FIG. 3 is a block diagram of a wireless transmitting device that accords with another embodiment of the invention;

FIG. 4 is a block diagram of a wireless receiving device that accords with another embodiment of the invention;

FIG. 5 is a flowchart for a method used within a wireless transmitting device according to an embodiment of the invention; and

FIG. 6 is a flowchart for a method used within a wireless receiving device according to an embodiment of the invention.

### DESCRIPTION OF THE EMBODIMENTS

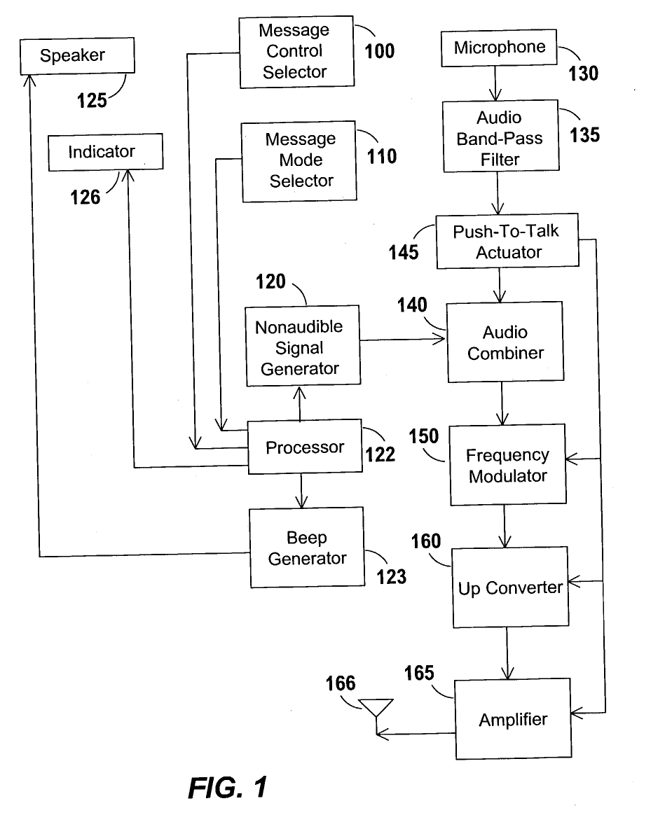

FIG. 1 is a block diagram of a wireless transmitting device that accords with an embodiment of the invention. In the device of FIG. 1, a nonaudible signal is generated and transmitted along with an accompanying voice message to indicate to a wireless receiving device that the voice message is to be recorded by the receiving device. In the embodiment of FIG. 1, microphone 130 is used to receive voice messages from a user. Microphone 130 can be any type of transducer that converts an acoustic signal into an electrical signal that represents the received acoustic energy. The output of microphone 130 is coupled to audio band pass filter 135, which limits the audio from microphone 130 to a particular frequency band, such as from 300 Hz to 3.5 kHz. The band-limited audio from audio band pass filter 135 is then coupled to audio combiner 140 by way of push-to-talk switch 145

Also coupled to audio combiner 140 is nonaudible signal generator 120. In the embodiment of FIG. 1, nonaudible signal generator 120 generates an unmodulated continuous-wave signal (i.e. a tone) that is outside the range of frequencies used to convey a voice message, such as below 300 Hz. Audio combiner 140 accepts the band-limited audio from audio band pass filter 135 and combines this audio with the nonaudible signal from signal generator 120 so that the nonaudible signal and the band-limited voice signal can be combined and simultaneously modulated by frequency modulator 150. The composite signal can then be up converted by way of up converter 160 and transmitted over a wireless communications channel by way of antenna 166.

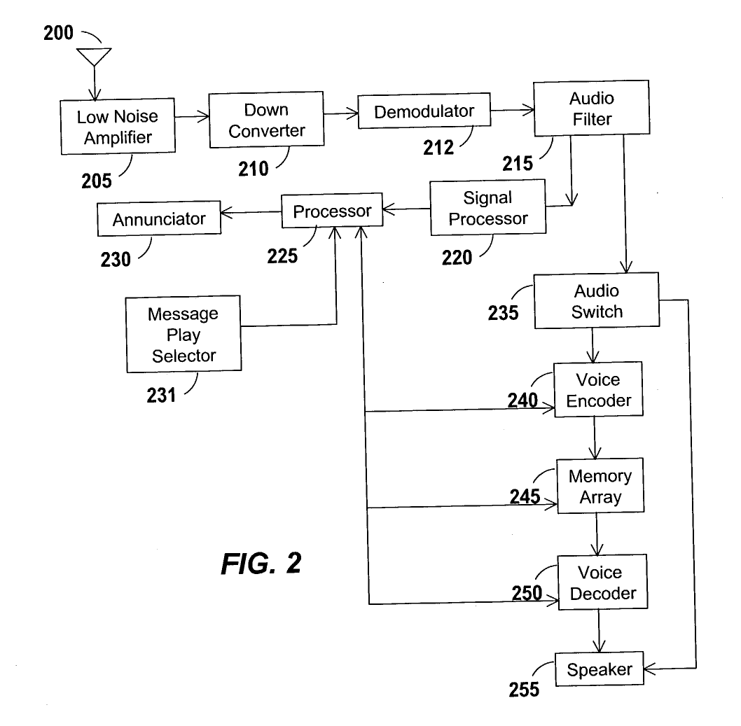

In a wireless receiving device, such as the device described in more detail in reference to FIG. 2 herein, the nonaudible signal is detected and used to instruct the wireless receiving device to record the accompanying voice transmission. Subsequent voice messages accompanied by similar nonaudible signal are also recorded by the wireless receiving device.

To activate nonaudible signal generator 120, the user actuates message mode selector 110. The output of message mode selector 110 is conveyed to processor 122, which, in turn, activates the nonaudible signal generator. Processor 122 also activates indicator 126 to alert the user that voice transmissions emanating from the wireless transmitting device of FIG. 1 will be recorded by any wireless receiving device that is tuned to the proper channel and within receiving range of the transmitting device. When the user is ready to begin talking, the user depresses push-to-talk actuator 145, which couples audio from audio band pass filter 135 to audio combiner 140. Push-to-talk actuator 145 also activates frequency modulator 150, up converter 160, and amplifier 165. When push-to-talk actuator 145 is released, frequency modulator 150, up converter 160, and amplifier 165 are returned to an inactive operating state.

The wireless transmitting device of FIG. 1 may also make use of nonaudible signals of different frequencies, perhaps also below 300 Hz, to instruct the wireless receiving device to perform message management tasks such as erasing a first stored message, replacing a previously-stored message with a second voice message, or playing a second stored message prior to playing a first stored message. In the embodiment of FIG. 1, message control selector 100, by way of processor 122, activates nonaudible signal generator 120 to produce signals that perform these tasks. For example, a 150 Hz tone may be used to instruct the receiving device to record an accompanying message, while a 200 Hz tone may be used to instruct the receiving device to erase a message. When transmitting instructions that merely instruct the receiving device to perform a message management task, and are not accompanied by a voice message, the user of the transmitting wireless device may be required to depress push-to-talk actuator 145 for only a short interval, such as from 1-3 seconds.

In FIG. 1 nonaudible signals from signal generator 120 are combined with the band-limited audio from audio band pass filter 135 and transmitted as a composite signal. However, in another embodiment, nonaudible signal generator 120 generates a tone at a frequency higher than the upper limit of audio band pass filter 135, such as 4 kHz. In another embodiment, nonaudible signal generator 120 generates more than one nonaudible tone and “chords” the tones together in a single output. The chorded tones are then combined with the audio signal from audio band pass filter 135 and the resulting composite signal is transmitted. An example of the use of chorded tones might include the use of a 150 Hz tone and a 200 Hz tone chorded together to produce an instruction to record an accompanying voice message.

In the previously-described embodiments of the invention, signal generator 120 has been described as generating one or more nonaudible tones that are transmitted concurrently with the audio from microphone 130. Upon detecting this signal, the receiving wireless device records the accompanying voice message. However, in other embodiments, nonaudible signal generator 120 may generate one or more tones as a preamble that is transmitted prior to transmitting an accompanying voice message. While nonaudible signal generator 120 is transmitting the preamble, processor 122 may instruct beep generator 123 to generate an audible signal to be conveyed to speaker 125. The audible signal (a “beep”) notifies the user that the preamble is transmitting, and that the user should refrain from speaking into microphone 130. It is contemplated that the preamble can be transmitted within 1-2 seconds, thus only requiring the user to refrain from speaking for only a short period of time.

The use of a preamble can be useful in wireless communications systems where unmodulated continuous-wave signals (or “group tones”) are used to identify transmissions to receiving devices as originating from users within a particular collection. When using group tones, a collection of users agrees on using a particular channel, as well as using a particular nonaudible tone (such as 150 Hz), which is transmitted concurrently with each voice transmission. The receiving devices ignore or suppress transmissions that are not accompanied by the correct tone. Thus, by using nonaudible group tones, two or more collections of users can share a single communications channel with minimal interference from users within other collections.

Thus, in a communication system in which nonaudible group tones are used to enable two or more collections of users to communicate on the same channel, the use of a nonaudible signal to instruct a receiving device to record an accompanying voice message could interfere with the nonaudible group tone already in use by a particular collection of users. In these systems, a nonaudible preamble can be transmitted prior to the voice transmission without interfering with the nonaudible group tone. For example, a particular series of nonaudible pulsed tones can be used to instruct the receiving device to record an accompanying voice message. Each pulsed tone can be of the same or a different frequency, or may consist of multiple tones chorded together.

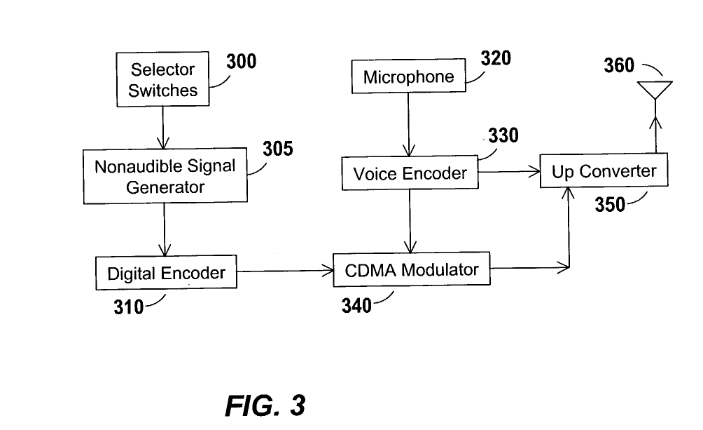

Although the wireless transmitting device of FIG. 1 is shown and described as making use of a frequency modulation technique, other modulation techniques may also be used. For example, frequency modulator 150 can be replaced by a code division multiple access (CDMA) modulator, as is described further in reference to FIG. 3. Additionally, any other type of linear or nonlinear modulator can replace frequency modulator 150. Further, frequency modulator 150 can be replaced by a modulator that operates in the digital domain in conjunction with a digital voice encoder that encodes band limited voice signals as well as nonaudible signals from signal generator 120. Suitable digital modulators include binary phase shift keying (BPSK) modulators, quaternary phase shift keying (QPSK) modulators, frequency shift keying (FSK) modulators as well as other modulators capable of transmitting encoded nonaudible signals as well as encoded voice messages across a wireless communications channel through a suitable up converter and antenna.

FIG. 2 is a block diagram of a wireless receiving device that accords with an embodiment of the invention. The receiving device of FIG. 2 receives a composite signal from the wireless transmitting device of FIG. 1 and stores the voice message present in the composite signal. An annunciator (230) is used to notify the user of the receiving device that a message has been stored in memory array (245) of the receiving device. The wireless receiving device of FIG. 2 and the wireless transmitting device of FIG. 1 are capable of communicating without the use of an intervening communications telecommunications infrastructure, such as the public switched telephone network (PSTN) or the cellular extension of the PSTN.

In FIG. 2, antenna 200 receives a composite signal from a wireless transmitting device. The composite signal is amplified by way of low noise amplifier 205 and down converted by way of down converter 210. The down-converted composite signal is then demodulated by way of demodulator 212 and conveyed to audio filter 215. Audio filter 215 separates the nonaudible signal information from the voice message and conveys the nonaudible signal to signal processor 220. The voice message present in the composite signal is routed to audio switch 235. In an embodiment in which the nonaudible signal includes one or more tones below the range of frequencies used to reproduce the voice message (such as 300 Hz to 3.5 KHz), audio filter 215 may make use of a low-pass filter to separate the nonaudible signal from the voice message. In the event that the nonaudible signal includes signals above the range of frequencies used to convey the voice message, audio filter 215 may make use of a high pass filter. In the event that the nonaudible signal includes a preamble, audio filter 215 may include a timing element that routes the nonaudible signal to signal processor 220 for the duration of the preamble.

When the nonaudible signal conveyed from the wireless transmitting device of FIG. 1 consists of one or more tones, transmitted either as a preamble of an accompanying voice message or concurrently with a voice message, signal processor 220 determines the frequency (or frequencies) present in the nonaudible signal. As a result of the determination made by signal processor 220, processor 225 commands audio switch 235 to route the received voice signal from audio filter 215 to voice encoder 240 for encoding into a digital format and storage into memory array 245. Processor 225 then instructs annunciator 230 to illuminate, thereby notifying the user that a voice message has been received and stored within memory array 245. In the event that signal processor 220 does not detect the presence of a nonaudible signal, processor 225 commands audio switch 235 to route the voice signal from audio filter 215 directly to speaker 255, which presents the received voice message to the user.

Although annunciator 230 has been described as being illuminated to notify the user that a message has been stored, nothing prevents the annunciator from making use of other methods of alerting the user that a message has been stored. Thus, annunciator 230 may include a discrete indicator lamp such as a light-emitting diode, or may include an indicator positioned at a location on the display of the wireless receiving device. The display may also indicate the number of voice messages that have been stored in memory array 245. Annunciator 230 can also include an actuator and a mass that vibrates in a manner that can be sensed by the user.

When the user of the wireless receiving device of FIG. 2 notices that annunciator 230 has been illuminated or is otherwise triggered to present an annunciation, the user can actuate message play selector 231, which commands processor 225 to play the voice message stored in memory array 245. Processor 225 then reads the message from memory array 245 and activates voice decoder 250 to convert the digitally formatted message to a voice message for presentation to the user by way of speaker 255.

As mentioned in the description of FIG. 1, the nonaudible signal transmitted from the wireless transmitting device may include information other than an instruction to the wireless receiving device to record the accompanying voice message. Thus, the nonaudible signal may include an instruction to processor 225 to erase a first stored message, replace a first stored voice message with a second voice message, or to play a second stored message prior to playing a first stored message. These additional operations are managed by way of processor 225.

Although described as being separate devices, it is contemplated that the elements of FIGS. 1 and 2 could be integrated into a single housing. Thus, antennas 166 and 200 may be the same antenna that both receives and transmits composite signals. Processors 122 and 225 may be the same processor performing both transmit and receive-related functions. Further, speaker 125 and 255 can be the same unit.

FIG. 3 is a block diagram of a wireless transmitting device according to another embodiment of the invention. In FIG. 3, selector switches 300 are used to place the wireless transmitting device into a voice-messaging mode, or to perform other message management tasks on one or more messages already stored in a memory of a wireless receiving device. The selections from selector switches 300 are conveyed to nonaudible signal generator 305, which generates a digital instruction (for use by a wireless receiving device) to record an accompanying voice message. Nonaudible signal generator 305 may generate this instruction by way preamble that is transmitted prior to an accompanying voice message, or by way of a message transmitted concurrently with the voice message.

The signal from nonaudible signal generator 305 is encoded by way of digital encoder 310 and conveyed to CDMA modulator 340. CDMA modulator 340 also receives an encoded voice message from microphone 320 by way of voice encoder 330. The composite signal from CDMA modulator 340 is then up converted using up converter 350 and transmitted over a wireless communications channel using antenna 360.

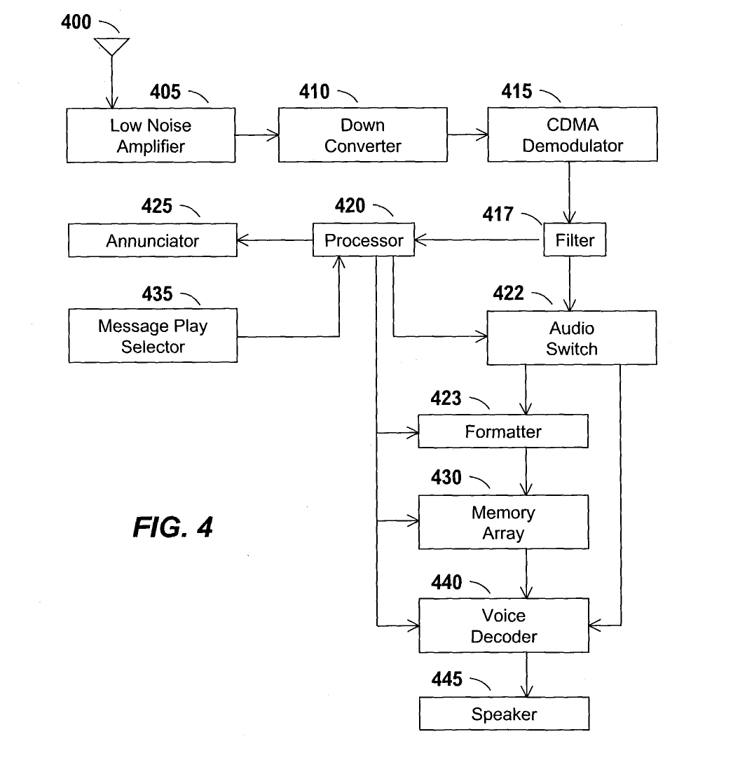

FIG. 4 is a block diagram of a wireless receiving device that accords with another embodiment of the invention. The wireless transmitting device of FIG. 3 and the wireless receiving device of FIG. 4 are capable of communicating without the use of an intervening communications infrastructure.

In FIG. 4, antenna 400 receives a composite signal that includes a nonaudible signal as well as a voice message transmitted over a wireless communications channel. The received composite signal is amplified by way of low noise amplifier 405 and down converted by way of down converter 410. The down converted composite signal is then conveyed to CDMA demodulator 415 which demodulates the composite signal and outputs encoded voice and a digitally-encoded instruction to filter 417. Filter 417 separates the encoded voice from the encoded instruction. The digitally-encoded instruction from CDMA modulator 415 is conveyed to processor 420 while the encoded voice is conveyed to audio switch 422.

In the event that processor 420 detects the presence of an encoded instruction that instructs the processor to record the accompanying voice message, the processor commands audio switch 422 to convey the encoded voice from filter 417 to formatter 423 so that the encoded voice message can be digitally formatted and stored in memory array 430. Processor 420 then illuminates or otherwise activates annunciator 425 to alert the user that a message has been stored in memory array 430. When convenient to do so, the user can select to play the stored voice message using message play selector 435. Upon selection of message play selector 435, processor 420 routes the stored message through voice decoder 440 to speaker 445 so that the stored message can be presented to the user.

In the event that the processor 420 does not detect an encoded instruction that directs the processor to record the accompanying voice message, audio switch 422 is instructed to convey the encoded voice from filter 417 through voice decoder 440 and play the incoming message using speaker 445.

Although described as being separate devices, it is contemplated that the elements of FIGS. 3 and 4 could be integrated into a single housing. For example, antennas 360 and 400 may be the same antenna that both receives and transmits composite signals.

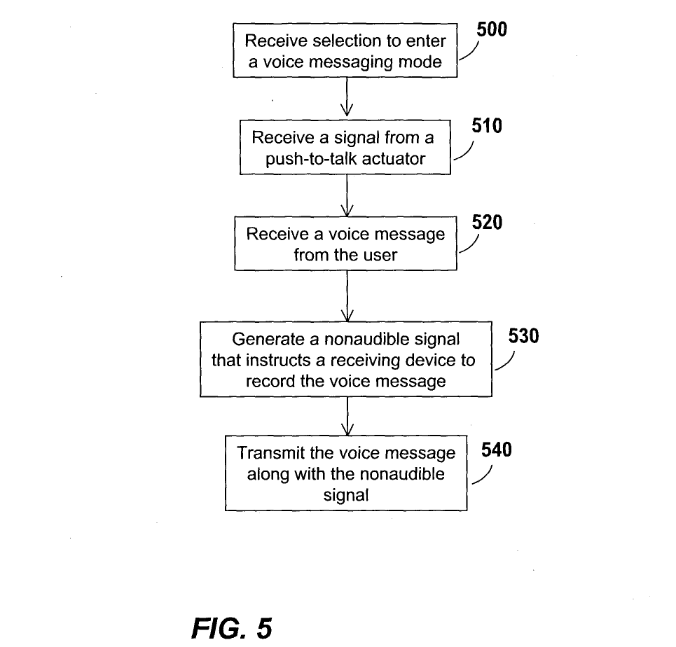

In the embodiments of FIGS. 2 and 4, audio switches 235 (FIG. 2) and 422 (FIG. 5) have been described as routing the voice message to either a memory (by way of voice encoder 240 or a formatter 423) or to a speaker. However, nothing prevents the audio switches from routing the voice message to both the memory and the speaker for simultaneous recording and reproduction through the speaker.

FIG. 5 is a flowchart for a method used within a wireless transmitting device according to an embodiment of the invention. The wireless transmitting device of FIGS. 1 and 3 are suitable for performing the method of FIG. 5. The method begins at step 500 in which a user selection to enter a voice messaging mode is received by the wireless transmitting device. In this mode, the wireless transmitting device transmits a nonaudible signal that instructs a wireless receiving device to record a voice message that accompanies the nonaudible signal. The voice message may be transmitted concurrently with the nonaudible signal, or may immediately follow the transmission of the nonaudible signal. The nonaudible signal can include a single tone, two or more tones chorded together, a series of single or chorded tone pulses transmitted in a series, or a digitally encoded instruction.

The method continues at step 510 in which a signal from a push-to-talk actuator is received. The push-to-talk signal conveys the user's intent to begin transmitting a voice message. At step 520, the wireless transmitting device receives a voice message from the user. It is contemplated that the voice message is received by way of a user speaking into a microphone of the device. At step 530, the wireless transmitting device generates a nonaudible signal that indicates that the accompanying voice message is to be recorded by the wireless receiving device. The method continues at step 540 in which the nonaudible signal and the accompanying voice message are transmitted over a wireless communications channel.

In some embodiments, not all of the steps shown in FIG. 5 may be required. For example, one embodiment of the invention may only include the steps of receiving a selection that causes the transmitting device to enter a voice-messaging mode (step 500), receiving the voice message from a user (step 520), and generating a nonaudible signal that indicates to the receiving device that the voice message is to be recorded by the receiving device (step 530).

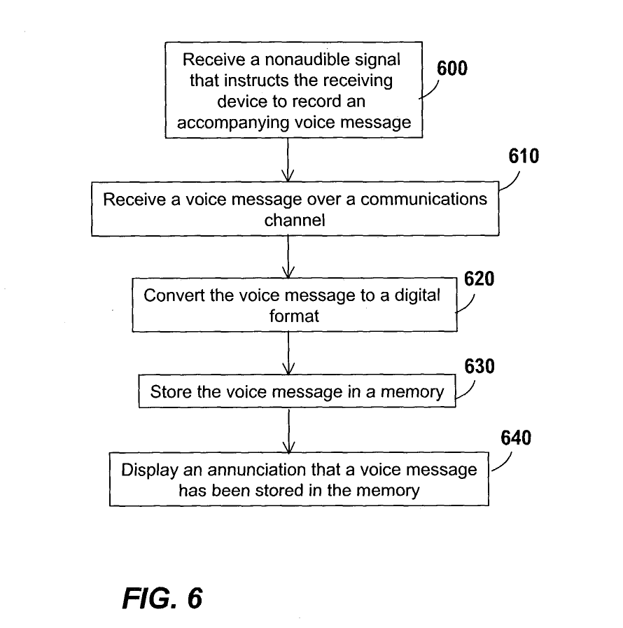

FIG. 6 is a flowchart for a method used within a wireless receiving device according to an embodiment of the invention. The wireless receiving devices of FIGS. 2 and 4 are suitable for performing the method. The method begins at step 600 in which the receiving device receives a nonaudible signal that indicates that an accompanying voice message is to be recorded. The method continues at step 610 in which the voice message is received using a wireless communications channel. Steps 600 and 610 may be performed concurrently in those embodiments where the nonaudible signal is combined with a voice message and the combination is transmitted as a composite signal. Step 610 may also follow step 600 in those embodiments where a preamble is used to notify the receiver that an accompanying message is to be recorded.

The method continues at step 620 in which the voice message is converted to a digital format by way of a suitable voice encoder such as voice encoder 240 of FIG. 2, or formatter 423 of FIG. 4. The method continues at step 630, in which the voice message is stored in a memory array. The method continues at step 640, in which the wireless receiving device displays an annunciation that a voice message has been received. The user can then select to play the recorded message at his or her convenience.

In some embodiments, not all of the steps shown in FIG. 6 may be required. For example, an embodiment of FIG. 6 may only include the steps of receiving a nonaudible signal that instructs the receiving device to record an accompanying voice message (step 600), receiving the voice message over a communications channel (step 610), converting the received voice message to a digital format (step 620); and storing the voice message in a memory (step 630).

In conclusion, while the present invention has been particularly shown and described with reference to the foregoing preferred and alternative embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

What is claimed is:

1. A method of indicating that a voice message to be transmitted by transmitting device is to be recorded by a receiving device, the method comprising:
receiving a selection that causes the transmitting device to enter a voice-messaging mode;
receiving the voice message from a user; and
generating a nonaudible signal that instructs a receiving device to record the voice message.

2. The method of claim 1, additionally comprising transmitting the voice message along with the nonaudible signal to the receiving device.

3. The method of claim 1, further comprising the transmitting device receiving a signal from a push-to-talk actuator while receiving the voice message from the user.

4. The method of claim 1, wherein the nonaudible signal is at least one tone that is transmitted concurrently with the voice message.

5. The method of claim 4, wherein the tone includes a frequency outside of the range of frequencies used by the transmitting device to convey the voice message.

6. The method of claim 1, wherein the nonaudible signal is at least one tone that is transmitted prior to transmitting the voice message.

7. The method of claim 6, wherein a series of the at least one tone is transmitted prior to transmitting the voice message.

8. The method of claim 1, wherein the nonaudible signal is a digitally encoded instruction.

9. The method of claim 1, wherein a second nonaudible signal is transmitted, the second nonaudible signal instructing the receiving device to perform one or more of the following: erase a message, replace a first message with a second message, play a second message prior to playing a first message.

10. In a receiving device, a method for recording a voice message, comprising:
receiving a nonaudible signal that instructs the receiving device to record an accompanying voice message;
receiving the voice message over a communications channel;
converting the received voice message to a digital format; and
storing the voice message in a memory.

11. The method of claim 10, wherein the nonaudible signal is received concurrently with the voice message.

12. The method of claim 11, wherein the nonaudible signal includes at least one tone at a frequency outside of the range of frequencies used by the receiving communications device to reproduce the voice message.

13. The method of claim 10, wherein the nonaudible signal is received as a preamble to receiving the voice message.

14. The method of claim 10, wherein the nonaudible signal is a series of at least one tone, the series being received prior to receiving the voice signal.

15. The method of claim 10, additionally comprising displaying an annunciation that a voice message has been stored in the memory.

16. The method of claim 10, additionally comprising the step of reproducing the voice message by way of a speaker.

17. A wireless transmitting device, comprising:
a selector that places the wireless transmitting device into a messaging mode; and
a nonaudible signal generator, coupled to the selector that generates a signal that instructs a wireless receiving device to record an accompanying voice signal.

18. The wireless transmitting device of claim 17, wherein the nonaudible signal generator generates at least one tone at a frequency in the 0 to 300 Hertz range.

19. The wireless transmitting device of claim 17, wherein the nonaudible signal generator generates two or more tones that are chorded together.

20. The wireless transmitting device of claim 17, wherein the nonaudible signal generator generates a series of two or more tones that are chorded together.

21. The wireless transmitting device of claim 17, wherein the nonaudible signal generator generates a digitally encoded message.

22. The wireless transmitting device of claim 17, additionally comprising a frequency modulator that converts the nonaudible signal and the accompanying voice signal to a frequency modulated signal.

23. The wireless communications device of claim 17, additionally comprising a code division multiple access (CDMA) modulators that converts the nonaudible signal and the accompanying voice signal to a CDMA signal.

24. A receiving device that stores received voice messages, comprising:
a filter that separates a received composite signal into a voice signal and a nonaudible instruction;
a signal processor that converts the nonaudible signal into a computer instruction; and
a computer processor that stores the voice message in a memory in response to receiving the computer instruction.

25. The receiving device of claim 23, additionally comprising an annunciator that notifies a user of the receiving device that a voice message has been stored in memory.

26. The receiving device of claim 25, wherein the annunciator is a vibrating device that can be sensed by the user.

27. The communications device of claim 24, wherein the signal processor converts a second nonaudible signal into a second computer instruction, the second computer instruction causing the computer processor to perform one or more of the group consisting of: erasing a first stored voice message, replace a first stored voice message with a second stored voice message, and playing a second stored message prior to playing a first stored message.

28. A transmitting device that transmits voice messages to a receiving device, the transmitting device comprising:
means for accepting a voice message from a user;
means for receiving a selection from the user; and
means for instructing the receiving device to record a voice message transmitted by the transmitting device, the means for instructing being activated by the means for receiving a selection from the user, wherein
the transmitting device and the receiving device communicate without the use of an intervening communications infrastructure.

29. The transmitting device of claim 28, wherein the means for instructing the receiving device to record a voice message includes a means for generating a nonaudible signal for transmission concurrently with the voice message.

30. The transmitting device of claim 28, wherein the means for instructing the receiving device to record a voice message includes a means for generating a preamble for transmission prior to transmitting a voice message

31. The transmitting device of claim 30, further comprising a means for notifying the user that the preamble is transmitting, and that the user should refrain from speaking into the means for accepting a voice message.

32. A receiving device that records voice messages received from a transmitting device, comprising;
means for receiving a composite signal;
means for separating a nonaudible signal from a voice message included in the composite signal, the nonaudible signal instructing the receiving device to record the voice message; and
means for recording the voice message, wherein
the transmitting device and the receiving device communicate without an intervening infrastructure.

33. The receiving device of claim 32, wherein the means for separating a nonaudible signal from a voice message includes an audio filter that separates one or more tones from the voice message.

34. The receiving device of claim 32, wherein the means for separating a nonaudible signal from a voice message includes an audio filter that separates one or more digitally-encoded instructions from the voice message.

35. The receiving device of claim 32, wherein the means for separating a nonaudible signal from a voice message includes a timing element that routes the nonaudible signal to a signal processor during the duration of the preamble.
